(19) United States
(12) Patent Application Publication
(10) Pub. No.: US 2004/0258131 A1
(43) Pub. Date: Dec. 23, 2004

(54) Parallel spread spectrum communication system and method

(76) Inventor: Kenneth Margon, Oakland, CA (US)

Correspondence Address: HUNTON & WILLIAMS LLP, INTELLECTUAL PROPERTY DEPARTMENT, 1900 K STREET, N.W., SUITE 1200, WASHINGTON, DC, 20006-1109, US

(21) Appl. No.: 10/462,822

(22) Filed: Jun. 17, 2003

(51) Int. Cl. H04B 1/69

(52) U.S. Cl. 375/130

(57) ABSTRACT

The invention involves a parallel spread spectrum (“PSS”) technique of spreading orthogonal encoded data. In a preferred embodiment, a method and system for communicating data comprises encoding and spreading a data stream using a scheme employing orthogonal Walsh functions, and thereby segmenting the data stream into multiple bit data packets representing one of a number of true or inverted Walsh codes. The data stream is then differentially encoded for either BPSK or QPSK modulation, and spread using a PN-sequence. The parallel spread data stream is modulated for transmission to a receiver. At the receiver, the data stream is recovered by computing a cross correlation between the digitized data stream and a programmed sequence. One of the benefits of the PSS techniques over conventional communication systems is that additional processing gain plus data forward error correction can be simultaneously achieved.

### CROSS-REFERENCE TO RELATED APPLICATIONS

The present application is related to U.S. patent application Ser. No. 10,075,367, entitled “Parallel Spread Spectrum Communication System and Method,” filed on Feb. 15, 2002; U.S. patent application Ser. No. ______, entitled “Parallel Spread Spectrum Communication System and Method,” filed Jun. 17, 2003; and U.S. patent application Ser. No. ______, entitled “System and Method for Single-Point to Fixed Multipoint Data Communication,” filed Jun. 17, 2003. The above-referenced patent applications are hereby incorporated by reference in their entirety.

### BACKGROUND OF THE INVENTION

1. Field of the Invention

The present invention relates to digital communications, and more particularly, to systems and methods for providing spread spectrum related communications.

2. Description of Related Art

Spread spectrum communication techniques are finding broad applications. For example, spread spectrum originated in the military where communications are susceptible to detection/interception and vulnerable to intentionally introduced interference/jamming. However, a host of commercial applications for spread spectrum has evolved, particularly in the area of wireless communications, such as cellular mobile communications.

The basic concept of spread spectrum is contrary to long standing communications practices. Particularly, conventional practices focused on minimizing the frequency bandwidth of an information-bearing signal in order to fit more signals onto a communications link (channel). The goal of spread spectrum, in contrast, is to substantially increase the bandwidth of an information-bearing signal. Indeed, a spread spectrum communications link occupies a bandwidth substantially greater than the minimum requirements for a standard communications link. That is, a spread spectrum signal typically occupies a bandwidth well beyond the bandwidth that is required to transmit digital data according to the Nyquist theorem. As discussed in greater detail below, this bandwidth increase helps mitigate the harmful effects of various forms of interference.

In a spread spectrum system, a transmitter spreads (increases) the bandwidth of an information-bearing signal prior to transmission. A receiver, upon receipt of the signal, despreads (decreases) the bandwidth by substantially the same amount. Ideally, the despreaded received signal is identical to the transmitted signal prior to spreading. However, the communication channel regularly introduces some form of narrow band (relative to the spread bandwidth) interference.

One general type of spread spectrum system is direct sequence spread spectrum (“DSSS”). With DSSS systems the spreading is achieved by multiplying the digital data with a binary pseudo-noise sequence “PN-sequence” or “PN-code”), which is alternatively known as a pseudo-random sequence or chipping code, whose symbol rate is many times the binary data bit rate. The spreading sequence symbol rate is sometimes called the chip-rate. The chipping code is independent of the data and includes a redundant bit pattern for each bit that is transmitted. The code, in effect, increases the transmitted signal's resistance to interference. If one or more bits in the pattern are damaged during the transmission, the original data can be recovered due to redundancy in the transmission. A pseudo-noise sequence is a sequence of chips valued at −1 or 1 (polar), or 0 and 1 (non-polar), which possess exceptional correlation properties.

FIG. 1 illustrates a conventional direct sequence (“DS”) spread spectrum spreading technique. There are several types of well known pseudo-noise sequences which can be used with DSSS systems, for example, M-sequences, Gold codes, and Kasami codes; each type of sequence or code having its own peculiar characteristics. The number of chips within one code is called the period (N) of this code. For instance, if a complete PN-sequence is multiplied with a single data bit (as in FIG. 1, with N=7), the bandwidth of the signal is multiplied by the factor N, which also is referred to as a processing gain. In other words, the processing gain in spread spectrum communications is directly related to the length of the sequence. Referring to FIG. 2A, the effect on the power spectrum is that the power spectral density has the shape of a sinc²(x) function, if a M-sequence code is used.

The benefits of using spread spectrum techniques can be readily seen through the necessity of interference suppression. There are generally three categories of inferences that a signal can experience: jammed, multiple access, and multipath. Jammed interference occurs when another signal is deliberating (as with a military jammer) or is inadvertently superimposed on the signal. Multiple access interference occurs when the signal shares the same frequency spectrum with other signals. Multipath interference occurs when the signal itself is delayed.

With respect to jammed interference, a hostile party or “jammer” has a difficult time locating a spread spectrum signal. In fact, after spreading, the spread spectrum signal is confused with the noise, see FIG. 2B, and a jamming signal is limited to a small part of the spectrum; after despreading of the signal, the jamming is attenuated to the level of noise, see FIG. 2C, and the information can be recovered, see FIG. 2D. In commercial applications, the primary advantage of spread spectrum communication is the elimination of concentrated interference from another transmitter.

Spread spectrum benefits regarding multiple access interference have great commercial utility. From the perspective of commercial applications, spread spectrum communications allow multiple users to communicate on the same frequency band. When used in this manner, it becomes an alternative to either frequency division multiple access (“FDMA”) or time division multiple access (“TDMA”) and is typically referred to as either code division multiple access (“CDMA”) or spread spectrum multiple access (“SSMA”). When using CDMA, each signal in the set is given its own spreading sequence. FDMA requires that all users occupy disjoint frequency bands but are transmitted simultaneously in time. TDMA requires that all users occupy the same bandwidth by allocating unique time slots to each user within each channel. In contrast, with CDMA the different waveforms are distinguished from one another at the receiver by the specific spreading codes they employ.

CDMA has been of particular interest for applications in wireless communications. These applications include cellular communications, personal communications services (“PCS”), and wireless local area networks. The reason for this popularity is primarily due to the performance that spread spectrum waveforms display when transmitted over a multipath fading channel. To illustrate this concept, consider DS signaling. As long as the duration of a single chip of the spreading sequence is less than the multipath delay spread, the use of DS waveforms provides a system designer with one of two options. The multipath can be treated as a form of interference, which means the receiver should attempt to attenuate it as much as possible. Indeed, under this condition, all of the multipath returns that arrive at the receiver with a time delay greater than a chip duration from the multipath return to which the receiver is synchronized (usually the first return) will be attenuated because of the processing gain of the system. Alternately, the multipath returns that are separated by more than a chip duration from the main path represent independent “looks” at the received signal and can be used constructively to enhance the overall performance of the receiver. That is, because all of the multipath returns contain information regarding the data that is being sent, information can be extracted by an appropriately designed receiver.

Thus, the benefits of spread spectrum communications are that different spreading codes can be used so that multiple links can operate on the same frequencies simultaneously. Another benefit afforded by this technique is that the processing gain allows spread spectrum communication links to work at much lower signal levels than conventional radio links.

Conventional spread spectrum systems, however, have several drawbacks. One problem with conventional wireless systems is that they have considerable RF transmitter power requirements. Particularly in portable hand-held cellular devices, it is believed that these power requirements and the associated strong electromagnetic signals of the device may negatively affect human physiology. Another relevant drawback with conventional systems is the short battery life of portable devices in certain applications. Additionally, conventional spread spectrum systems require a large communication bandwidth and the number of users on each bandwidth is limited by the number of spreading codes.

Another drawback is that spread spectrum is subjected to the NEAR-FAR effect. This problem is caused by the fact that a receiver may receive several signals with unequal powers from multiple transmitters. Generally the transmitted signal power from a non-reference transmitter is suppressed in the receiver by the cross-correlation properties of the reference code. However, if the non-reference transmitter is much closer than the reference transmitter it is probable that the received signal from the non-reference transmitter will constitute substantially more power than the reference transmitter. In this case, the PN correlator in the receiver shall be unable to detect and despread the weak reference transmission.

Another significant drawback is that conventional systems cannot pragmatically and efficiently provide enhanced processing gain. Currently, spread spectrum techniques do not support large PN-sequence lengths that improve processing gain. In addition, conventional systems are unable to utilize-optimal processing gain simultaneously with forward error correction.

### SUMMARY OF THE INVENTION

The present invention teaches bi-sequential parallel spread spectrum methods and systems. The invention advantageously combines a series of code sequences to produce an enhanced and robust communications technique that can be implemented in a broad variety of applications, including point-to-point or point-to-multipoint wireless communication systems.

In one preferred embodiment of the invention, a wireless communication system includes a transmitter and a receiver station. A bi-sequential parallel spread spectrum method that includes the combination of a primary and a secondary code sequences is utilized. In accordance with the invention, the transmitting station performs the steps of encoding a digital data signal with a primary coding scheme comprising primary codes, such as an orthogonal Walsh coding scheme; spreading equally divided portions of the primary codes with a secondary sequence, such as a PN-sequence; modulating the spread encoded signal, using for example, DBPSK modulation; and transmitting the modulated signal. The receiver station, in accordance with this preferred embodiment, performs the steps of despreading the received signal using a stored secondary sequence; demodulating the despreaded signal; and decoding the demodulated signal using the primary coding scheme.

In an embodiment of the invention, a method of deriving code pairs for use in a CDMA communication system comprises the steps of: selecting a number of n-bit orthogonal codes; ordering the number of n-bit orthogonal codes into a first order; generating permutations of the first order; for each permutation of the first order, generating a first group of unique codes, wherein the step of generating comprises inverting at least one of the number of n-bit orthogonal codes; and reversing the first group of unique codes to create a reversed group of unique codes; measuring a separation value between each possible code pair of the groups, wherein each possible code pair consists of one code selected from one of the first groups of unique codes and one code selected from the reversed groups of unique codes, and determining a set of code pairs, wherein all of the code pairs in the set of code pairs have a measured separation value greater than 30 dB using Walsh codes.

The use of multiple short spreading codes in parallel layers radically enhances processing gain and multiple access attributes. In one embodiment of the invention, an enhanced processing gain of approximately 27 dB is achieved.

Another significant advantage of the invention is that the enhanced processing gain allows for a reduction in transmitted power requirements and/or an increase in communication distance. For example, an 18 dB processing gain theoretically means that only ⅛ of the RF transmitter power requirement is necessary for the communications link. The lower power requirements of the invention may reduce health issues and allow for longer battery use in certain applications. Moreover, communication distances of up to 50 km can be achieved.

An additional advantage of the invention is that independent spreading sequences can be utilized in both the In-phase and Quadrature channels thereby, allowing enhanced communications link security.

Yet another advantage of the invention is improved bandwidth efficiency. For example, the invention typically provides more than five (5) times greater bandwidth efficiency than conventional spread spectrum techniques with identical processing gain attributes.

Another advantage of the invention is that forward error correction algorithms can be implemented at the receiver to improve bit-error rate performance.

A further advantage of the invention is the use of a reduced acquisition period due to the use of short PN-sequences.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the invention, the objects and advantages thereof, reference is now made to the following descriptions taken in connection with the accompanying drawings in which:

FIG. 1 illustrates a conventional direct sequence spread spectrum spreading technique;

FIGS. 2A-2D illustrate frequency spectra in a conventional direct sequence spread spectrum communication system;

FIG. 3 illustrates a parallel spread spectrum communication system according to an embodiment of the invention;

FIG. 4 illustrates a process for transmitting a parallel spread spectrum signal according to an embodiment of the invention;

FIG. 5 illustrates a process for receiving a parallel spread spectrum signal according to an embodiment of the invention;

FIG. 6(a) illustrates a signal diagram of parallel spreading of data according to an embodiment of the invention;

FIG. 6(b) illustrates a signal diagram of parallel spreading of data according to another embodiment of the invention;

FIG. 7 illustrates a single channel parallel spread spectrum transmitter system according to an embodiment of the invention;

FIG. 8 illustrates a hardware component diagram of a QPSK differential encoder according to an embodiment of the invention;

FIGS. 9(a) and 9(b) illustrate a parallel spread spectrum receiver system according to an embodiment of the invention;

FIG. 10 illustrates a Walsh code correlation and decoding circuit according to an embodiment of the invention;

FIG. 11 illustrates a hardware component diagram of a differential PSK demodulator according to an embodiment of the invention;

FIG. 12 illustrates a dual channel parallel spreading system according to an embodiment of the invention;

FIG. 13 illustrates an automatic gain control system according to an embodiment of the invention; and

FIG. 14 illustrates possible 64-bit code sequences derived from three exemplary 16-bit Walsh Codes according to an embodiment of the invention.

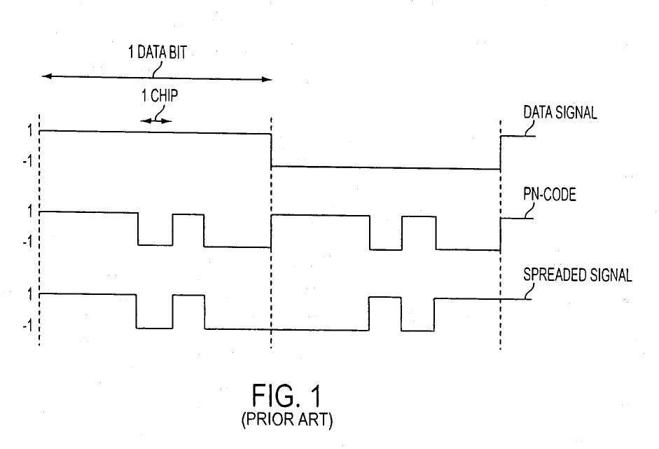

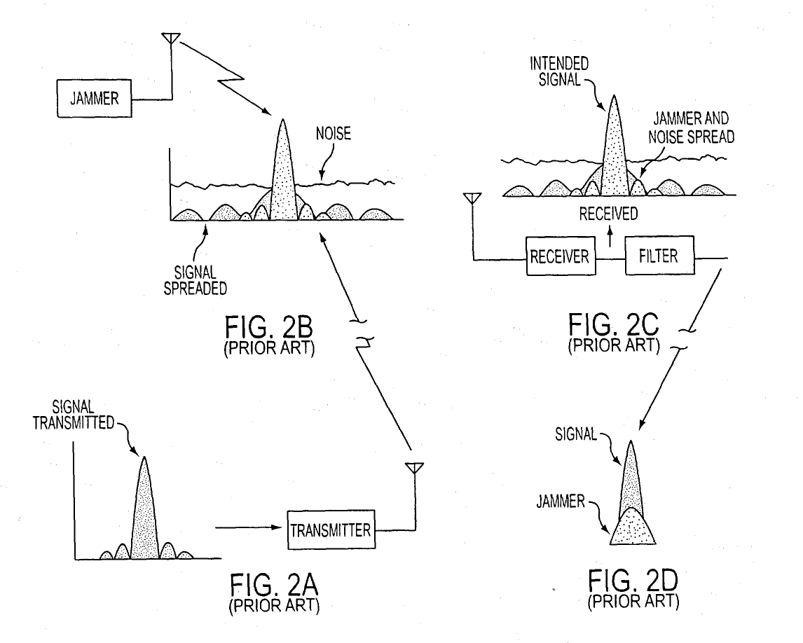

### DETAILED DESCRIPTION OF PREFERRED EMBODIMENTS

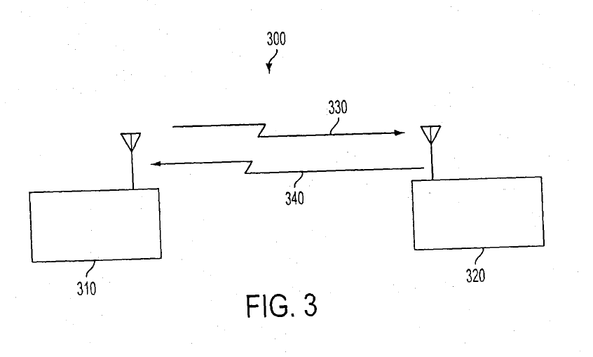

The preferred embodiments of the invention are now described with reference to FIGS. 3-14, wherein like reference numbers indicate like elements and the left most digit(s) of each reference number corresponds to the figure in which the reference number is first used. These preferred embodiments are discussed in the context of a wireless communication system. The invention can be practiced in a wide range of applications such as, but not limited to broadband wireless point-to-point and point-to-multipoint digital communications links; low power wireless applications such as satellite and deep space communications; telemetry applications using CDMA; WLAN applications; and secure communication channels. The preferred embodiments involve parallel bi-sequential spread spectrum (“PBSS”) techniques of spreading coded data over a predetermined secondary sequence.

The invention can be applied to any existing digital communications channel or link to essentially create a pseudo direct sequence spread spectrum communications link utilizing bit(s) by bit(s), byte by byte [B×B] or multiple byte [MB×MB] parallel spreading of an input digital stream of data. When combined with a DSSS communications channel, a dual layered parallel spreading of the data stream occurs. The invention widens the bandwidth requirements and greatly increases the processing gain for the communications link.

Referring to FIG. 3, a spread spectrum communication system 300 is depicted according to an embodiment of the invention. System 300 comprises transceiver stations 310 and 320. Transceiver station 310 communicates a parallel spread spectrum signal 330 to transceiver station 320. To facilitate bilateral communications, transceiver station 320 transmits a parallel spread spectrum signal 340 to transceiver station 310. One of ordinary skill in the art will recognize that parallel spread spectrum signals 330 and 340 can be further transmitted via a wireless network (not shown), such as a cellular phone service network or personal communications services (“PCS”) network. For example, transceiver station 310 and transceiver station 320 can be in the same cell or different cells of a cellular network or in cells of two different networks. The cellular network can comprise one or more base stations, which each operate in a respective cell, and a central office referred to as a mobile telephone switching office (“MTSO”). Each base station can comprise one or more transmitters and/or receivers that relay parallel spread spectrum signals 330 and 340 to enable a cellular network to communicate with transceiver station 310 and/or transceiver station 320. In such embodiments, the MTSO handles all phone connections to land-based phone systems and other cellular networks, and controls all of the base stations in a particular region. Parallel spread spectrum signals 330 and 340 can be converted at a base station or the MTSO into a differently formatted signal depending on the format required by a land-based communication system or other cellular network as necessary.

Signals 330 and 340 are preferably carried on radio frequency (RF) channels, such as, but not limited to those suitable for cellular communication devices, including both PCS and global system for mobile communications (GSM) devices; radio-controlled devices, including both civilian and military applications; satellite communication systems; and deep space radio communication systems.

In a preferred embodiment of the invention, transceiver stations 310 and 320 serve as a base station and a remote station, respectively, in a fixed wireless communications system as described in copending U.S. patent application Ser. No. ______, entitled “System and Method for Single-Point to Fixed Multipoint Data Communication,” and filed January Jun. 17, 2003. In such an embodiment, the parallel spread spectrum signals 330 and 340 are employed to carry packetized voice and data via an Internet Protocol Multiple Access (iPMA) communications methodology. Multiple remote stations (not shown) may also be employed to communicate with the base station. The base station is preferably interfaced with a telecommunications company (Telco) network and/or Internet Service Provider (ISP) network.

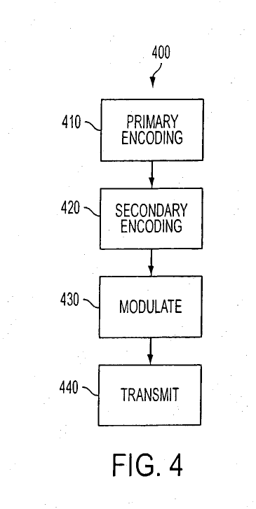

Parallel spread spectrum signal 330 is generated according to process 400 depicted in FIG. 4. In an embodiment of the invention, transmitting station 310 encodes (step 410) a digital data signal with a primary coding scheme. The primary encoding scheme employs orthogonal codes, such as orthogonal Walsh functions, of length 2ⁿ, the generation of which is apparent to one of ordinary skill in the art. For example, the primary codes may be four (4), eight (8), or sixteen (16) bit Walsh codes. Secondary encoding is performed (step 420) with a secondary code to spread the primary encoded data. The secondary code can be any type of an even ordered code, for example, M sequence, Barker, Gold, Kasami, and the like, but preferably, a PN-sequence. The secondary code is synchronously multiplied across the entire primary sequences or portions thereof with the requirement that the secondary sequence is an integer multiple of the length of the primary sequences. For example, if the primary codes are eight (8) bit Walsh codes, the secondary code must be a integer multiple of eight (8), for example, sixteen (16), twenty-four (24), thirty-two (32), forty-eight (48), or sixty-four (64), etc., bit PN-sequence. Upon completion of secondary encoding, the signal is modulated (step 430) and then transmitted (step 440) to receiving station 320.

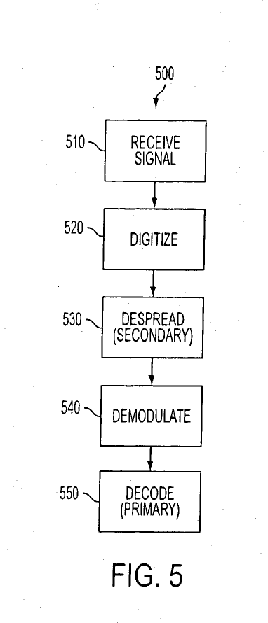

FIG. 5 illustrates a process 500 for receiving parallel spread spectrum signal 330 according to this preferred embodiment of the invention. Parallel spread spectrum signal 330 is first received (step 510) at receiving station 320. The parallel spread spectrum signal 330 is digitized (step 520) and then despread (step 530) using a stored secondary sequence corresponding to the secondary sequence used by transmitting station 310. Upon completion of despreading, the signal is demodulated (step 540) and then decoded (step 550) using the scheme employed in transmitting station 310.

With this embodiment, a potential processing gain of up to 27 dB (as the following details will illustrate) can be achieved if an eight (8) bit Walsh code is used as the primary sequence and a forty-eight (48) PN-sequence is used as the secondary sequence. Higher levels of processing gain can be achieved by using longer length primary and/or secondary codes. However, the level of complexity in receiving station 320 electronics is directly proportional to the length of the codes, and hence may limit the practical application of larger codes. Comparatively, to achieve a processing gain of 27 dB in a conventional DSSS system, a spreading code of 502 bits would be necessary, which is extremely impracticable for high data rate applications using current technology.

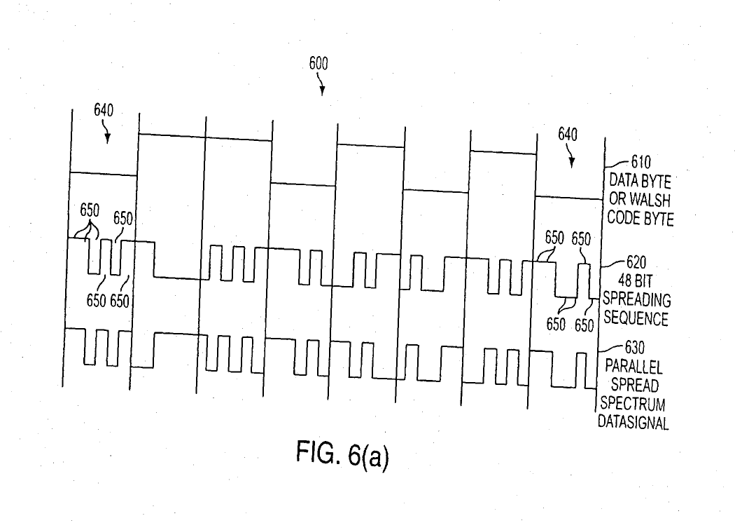

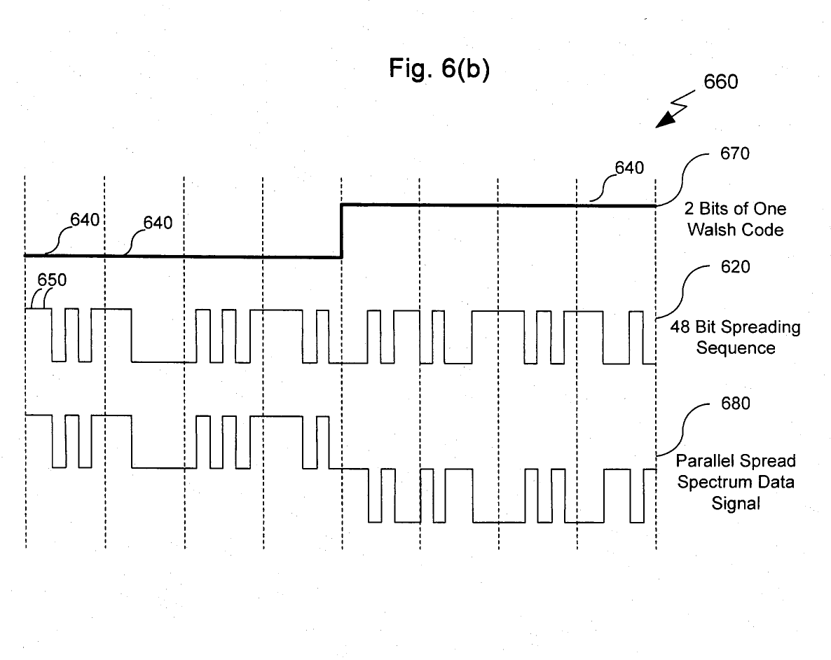

FIG. 6(a) illustrates a signal diagram 600 of parallel spreaded data as disclosed in commonly-assigned U.S. patent application Ser. No. 10/075,367. As shown, an eight (8) bit orthogonal code 610 is spread by a forty-eight (48) bit parallel PN-sequence 620 resulting in a parallel spread spectrum data signal 630. As previously stated, the parallel sequence is an integer multiple of the chosen length of the orthogonal code. Each data symbol 640 is spread by six (6) bits 650 of a parallel spreading sequence resulting in a potential processing gain of 7.78 dB (10 log 6). Once the appropriate orthogonal and parallel PN-sequence are chosen they are fixed for the duration of a communications session. CDMA communications can be achieved when each receiver is allocated different orthogonal PN-sequences.

In an embodiment of the present invention, each Walsh Code is divided into equal portions, each of which is spread by the parallel PN-sequence 620. Referring to FIG. 6(b), a signal diagram 660 of parallel spreaded data is illustrated according to this embodiment. As shown, the first two bit portion 670 of the Walsh Code 610 is spread by a forty-eight (48) bit parallel PN-sequence 620 resulting in a parallel spread spectrum data signal 680. Each data symbol 640 is spread by six (6) bits 650 of the parallel spreading sequence. In essence, four (4) six (6) bit portions of PN-sequence 620 are used for each bit of the Walsh code byte 610 input. Successive two bit portions of the Walsh Code 610 are also spread by the forty-eight (48) bit parallel PN-sequence 620. The use of two bit portions 670 is exemplary only; alternatively, one bit portions or four bit portions of an eight bit Walsh code can be used. Use of two bit portions 670 as described above has results in potential processing gain of 24.4 dB, e.g., the sum of the primary code processing gain, 9 dB; coding gain, 1.6 dB; and a secondary processing gain (10 log 24), 13.8 dB. The use of one bit portions creates a potential processing gain of approximately 27 dB. In order to maintain a sufficient data rate for voice communications, Quadrature Amplitude Modulation (QAM) is preferably employed instead of DPSK as described, infra.

In essence, a large parallel spreading sequence is used over multiple data bytes or portions thereof. The spreading sequences utilized can be, for example, M sequence, Barker, Gold, Kasami, or any type of PN-sequence. The parallel spreading in accordance with the invention can utilize differential encoding of the data stream in the transmit path to simplify data recovery in the receiver. If the parallel spreading scheme is applied to a M-ary modulation link then both in-phase (I) and quadrature (Q) channels can be spread using different PN-sequences to enhance channel security.

M-ary modulation systems send more information per transmitted signal transition (symbol) than binary systems. Since log₂(M) bits are required to select one of M possibilities, each waveform conveys log₂(M) bits of information. Each transmitted waveform represents a log₂(M)-bit symbol. Examples of M-ary schemes are illustrated in Table 1.

TABLE 1
M-ary schemes.

| M-ary | Modulation Scheme |
|---|---|
| 4 | QPSK |
| 8 | 8 PSK |
| 16 | 16 QAM |
| 64 | 64 QAM |

Walsh encoding of the primary data provides initial spreading and coding gain. An eight (8) bit Walsh encoder will provide a potential processing gain of 9 dB and coding gain of 1.6 dB. The link preferably uses an advanced protocol such as iPMA and data is conveyed in packet format. A preamble signifies the start of transmission to initialize acquisition at the receiver. In an embodiment of the invention, differential binary phase-shift keyed (“DBPSK”) modulation is initially utilized for the preamble and DQPSK for subsequent data packet transmission. Differential refers to the fact that the data is transmitted in the form of discrete phase shifts Δθ, where the phase reference is the previously transmitted signal phase. This method reduces the complexity of the demodulation process as an absolute phase reference is not required

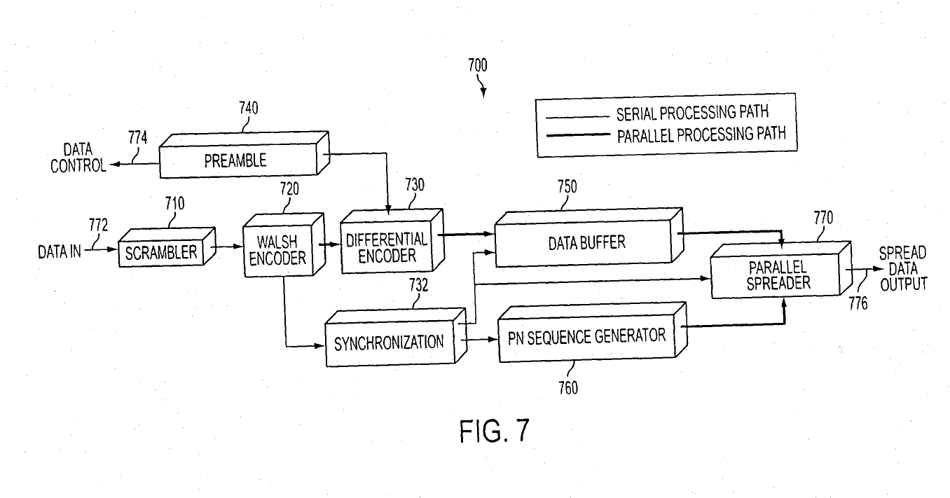

FIG. 7 illustrates a parallel spread spectrum system 700 with a single channel according to an embodiment of the invention. Incoming data 772 is scrambled by a scrambler 710 to spectrally whiten and remove any DC offset from the data. In this embodiment of the invention, orthogonal Walsh functions are used to encode and spread the data stream with a Walsh encoder 720. The resulting data is segmented into four (4) bit nibbles with three (3) bits defining magnitude and the remaining bit designating sign. The magnitude bits identify one of eight (8) Walsh codes and the sign bit defines whether a true or inverted Walsh code is selected. This introduces system processing gain in the form of both the spread and the coding. The spreading gain is 9 dB (10 log 8) while the use of highly orthogonal Walsh functions provides a coding gain of 1.6 dB. Thus, the use of Walsh codes provides an effective system gain of 10.6 dB. However, alternative digital modulation schemes involving in-phase (I) and a quadrature (Q) channels can be used with the invention.

M-ary bi-orthogonal keying (“MBOK”) modulation is a technique whereby the data is block encoded using orthogonal codes and can be implemented in binary (“BMBOK”) or Quadrature (“QMBOK”) format. This technique generates a coding gain which improves the link bit error rate (“BER”) performance through implementation of FEC algorithms at the receiver. Therefore, MBOK modulation is more efficient than BPSK, for example, E_{b}/Nₒ is 8 dB as opposed to 9.6 dB at 1e10⁻⁵ BER.

It should be noted that Walsh encoding can be implemented as part of the preferred embodiment with the above-identified benefits and advantages, but in alternative embodiments it can be circumvented with the additional processing gain being obtained directly from parallel spreading. Walsh encoding is preferred because of the orthogonality of the codes and the FEC attributes that can be achieved. Walsh codes exhibit zero cross-correlation only when there is zero phase offset or perfect synchronism. When offset, Walsh codes exhibit much larger cross-correlation values and much worse auto-correlation than PN-sequences. Hence, the overlaid parallel PN spreading sequences are used to extract the phase and timing information necessary to coherently decode the Walsh sequences at the receiver. Unencoded preambles are initially transmitted in order to achieve initial acquisition at the receiver. A preamble generator 740 generates the preamble for Walsh encoding at differential encoder 730 and data control signals 774, which are sent to a medium access controller (“MAC”) (not shown) to control the flow of data between the host system and the radio section.

Differential encoding of the data stream occurs to simplify the phase determination requirement in the demodulation process. A differential encoder 730 utilizes the previous symbol as a phase reference for determining the current symbol decision. This negates the prerequisite for the transmission of a constant phase reference in a coherent detection system. Differential encoding for BPSK modulation is achieved by simply XORing the present and previous symbol values. However, differential encoding for QPSK is more complex as there are sixteen possible states as shown in Table 2.

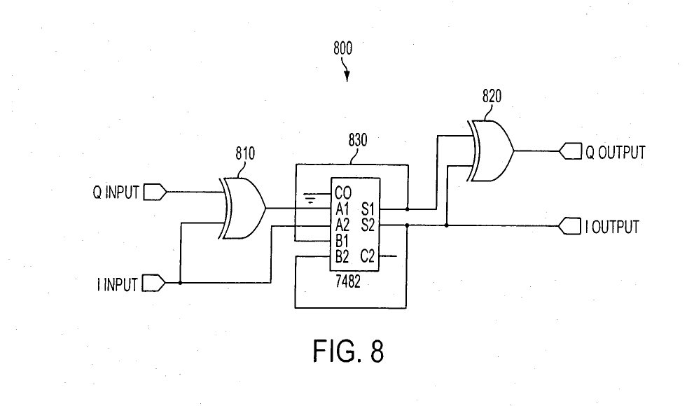

FIG. 8 illustrates a QPSK differential encoder circuit 800 according to an embodiment of the invention. Hardware comprises quadruple two-input exclusive-or gates 810 and 820 connected to two-bit adder 830. The operation of circuit 800 would be apparent to one of ordinary skill in the art.

TABLE 2
Differential Encoder Sequence QPSK

| New Input | Previously Encoded OUT (I,Q)ₖ₋₁ | | | |
|---|---|---|---|---|
| IN(I,Q)ₖ | 0 0 | 0 1 | 1 1 | 1 0 |
| 0 0 | 0 0 | 0 1 | 1 1 | 1 0 |
| 0 1 | 0 1 | 1 1 | 1 0 | 0 0 |
| 1 1 | 1 1 | 1 0 | 0 0 | 0 1 |
| 1 0 | 1 0 | 0 0 | 0 1 | 1 1 |

Referring to FIG. 7 again, a data buffer 750 holds the data byte(s) prior to parallel spreading and ensures that the data and PN-sequence can be synchronized. For example, Walsh encoder 720 provides synchronization pulses to a synchronizer 732. To ensure that the Walsh codes and PN-sequences are aligned in time, synchronizer 732 provides timing information to data buffer 750, a PN-sequence generator 760 and a parallel spreader 770. PN generator 760 is programmed to generate short through to very long PN-sequences. The PN-sequence spreads the data in parallel via parallel spreader 770 with multiple PN bits per data symbol. Output data stream 776 is modulated using a digital modulation scheme such as BPSK or QPSK.

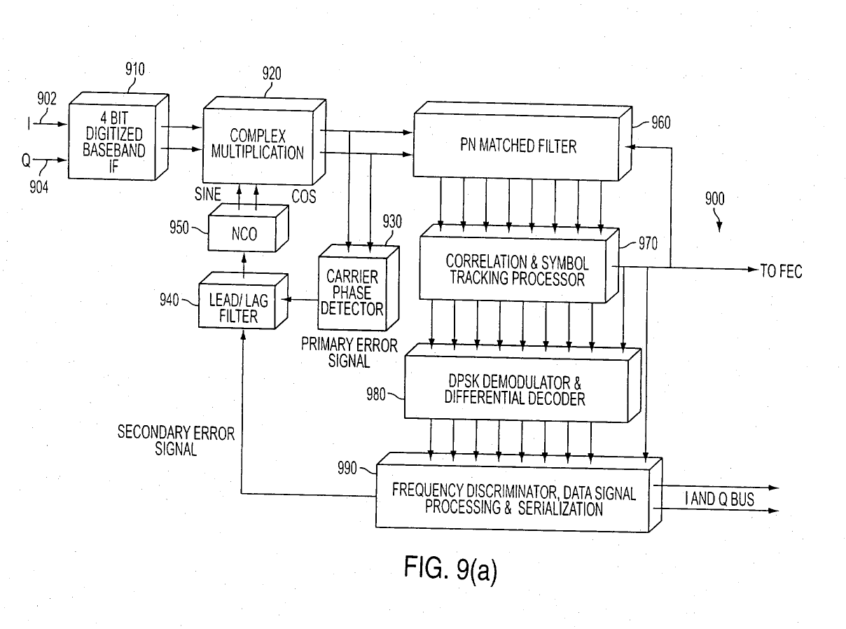

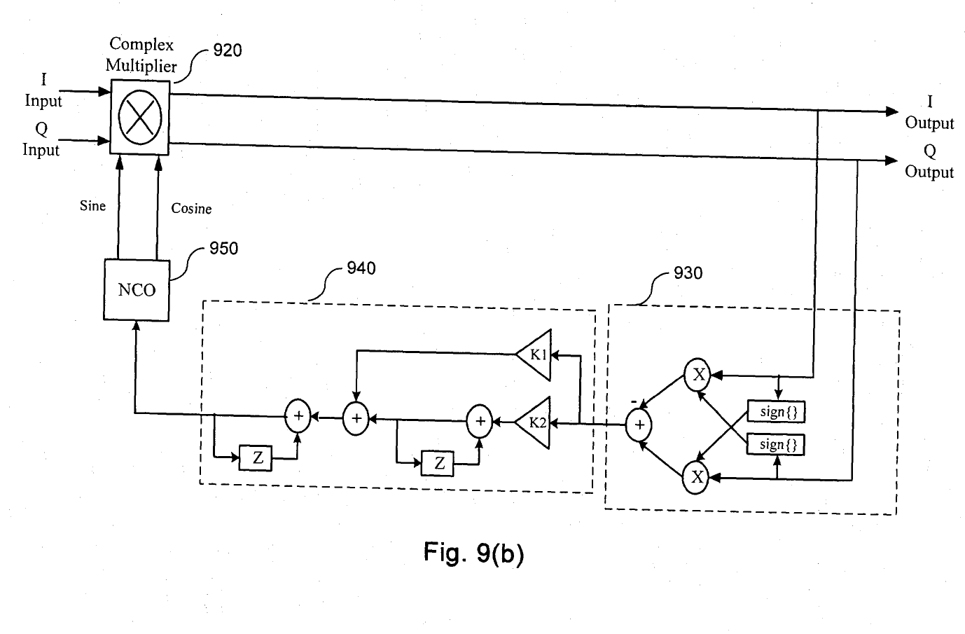

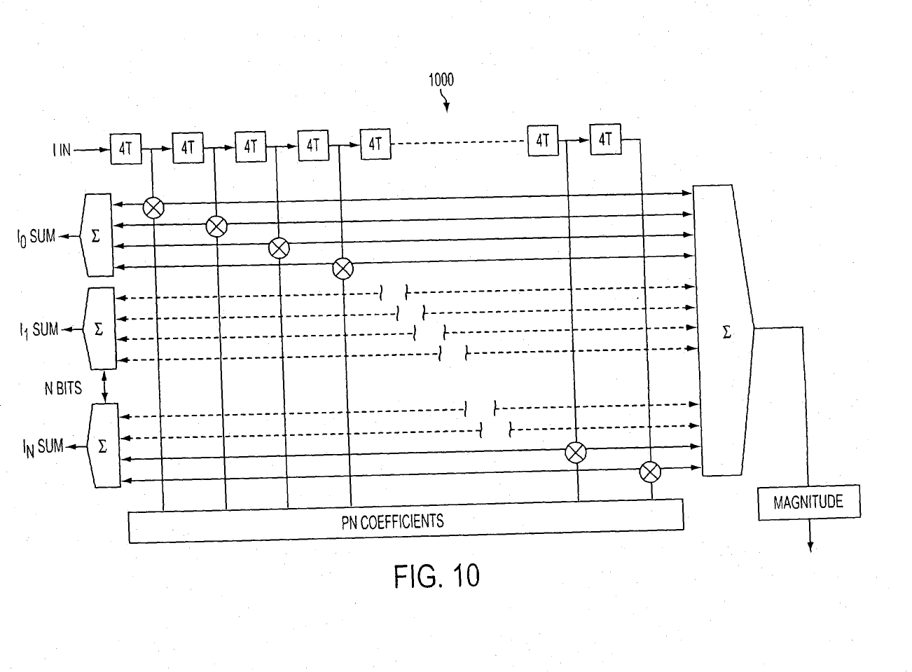

FIG. 9(a) and FIG. 10 illustrate the major components of a parallel spread spectrum system (receiver) 900 according to an embodiment of the invention. FIG. 9(a) illustrates both 1902 and Q 904 channels in which DPSK is the modulation scheme. FIG. 10 illustrates the Walsh code correlation and decoding circuit 1000 along with FEC; to enhance clarity, the In-phase [I] channel is illustrated only, however other channels may be used. The operation of circuit 1000 would be apparent to one of ordinary skill in the art.

Referring to FIG. 9(a), receiver 900 despreads the parallel spread sequence according to an embodiment of the invention. Specifically, an IF signal is down-converted to base-band where it is digitized by a dual four (4) bit analog to digital converter (“ADC”) 910. A sampling rate of four times the maximum chip rate is preferably utilized. A carrier tracking digital phase locked loop (“PLL”), or carrier phase recovery loop, is provided by a carrier phase detector 930, a lead/lag filter 940, and a numerically controlled oscillator (“NCO”) 950, the output of which is supplied to a complex multiplier 920.

Optimum data detection at the receiver 900 requires synchronization of receiver signal parameters with those corresponding at the transmitter to ensure that data detection can continue over deteriorating channels, such as with fading and large carrier offsets. Carrier frequency error is mostly due to propagation channel effects and/or transmitter/receiver circuitry. The I and Q channel signals received are typically subjected to frequency and phase error resulting from mismatch frequency and un-synchronized phases between the transmitter and the receiver 900. The purpose of the DPLL is to remove any carrier offset that would be attributed to tolerances in the RF down-conversion process, thereby aligning the frequency and phase of the receiver 900. FIG. 9(b) illustrates particulars of a carrier phase recovery loop, the operation of which would be apparent to one of ordinary skill in the art, of receiver 900 implemented for DBPSK/DQPSK modulation according to an embodiment of the invention. I and Q input signals are passed through the carrier phase detector 930 and lead/lag filter 940, which generates error signals used by the NCO 950 to create phase correction coefficients. Particularly, digitized I and Q-channel data from the ADC 910 are mixed with the cosine and sine output of the NCO 950, respectively at complex multiplication 920. A NCO is an oscillator which generates digital sample values corresponding to sinusoidal or other waveforms. The carrier phase recovery loop properly compensates for carrier offsets by constantly adjusting the I and Q values, thereby aligning and synchronized the phase prior to the data samples being introduced to the PN matched filter correlator 960.

PN matched filter 960 comprises a uniquely programmable multi-stage serial sliding correlator. In operation, PN matched filter 960 computes the cross correlation between the input and the programmed PN maximal sequence. The correlation peak is utilized to initialize a parallel accumulate, integrate, and dump sequence which, in turn, extracts both the multi-byte samples and byte timing information. The product from each of the bit accumulators in PN matched filter 960 are fed in parallel to a correlation and symbol tracking processor 970 where correlation of each bit is confirmed and the symbol timing information is extracted from the extracted data samples. Correlation is achieved by computing the magnitude of the sums of the I and Q channel correlation sums approximated by the equation, Max [ABS(I)*ABS(Q)]+½ Min[ABS(I)*ABS(Q)]. The computed value is used to generate the multi-byte tracking reference clock signal.

Programmable thresholds and intelligent tracking are implemented to ignore false detects and automatically insert missing correlation pulses. This multi-byte detection pulse initializes the parallel correlation which extracts the symbol timing by computing the magnitude of the symbol correlation power which in turn forms a reference for the symbol tracking process. The extracted despread symbol samples along with correlated timing information from the symbol tracking processor are then forwarded to a DPSK demodulator 980.

DPSK demodulation is carried on each symbol by computing the “dot” and “cross” products for each using the despread information from the current and previous parallel correlation process. For BPSK modulation the “dot” product alone allows determination of the phase shift between successive samples. For QPSK modulation both the “dot” and “cross” products are necessary to determine the phase shift. Mathematically, the dot and cross products are given by;

dot(k)=I_{K}·I_{K-1}+Q_{K}·Q_{K-1} and,

cross(k)=Q_{K}·I_{K-1}−I_{K}·Q_{K-1},

where I and Q are the In-phase and Quadrature samples for the current, K, and previous, K−1, symbols. Examination of these products in the complex plane reveals that this method will correctly demodulate differentially encoded QPSK signals in the format illustrated in Table 2.

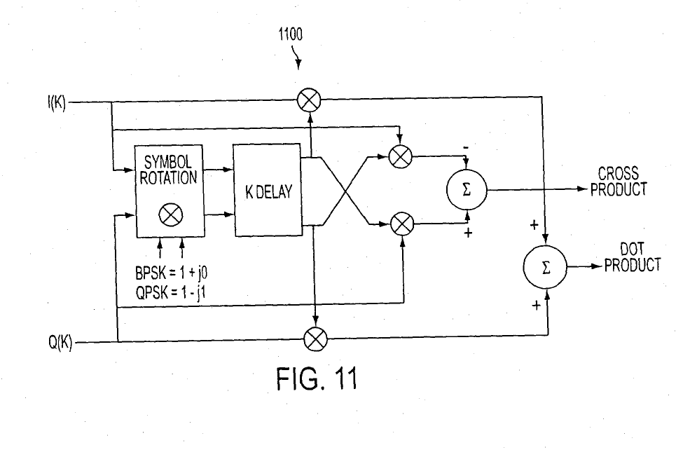

A hardware implementation of a differential PSK demodulator 1100 according to an embodiment of the invention is illustrated in FIG. 11. The operation of demodulator 1100 would be apparent to one of ordinary skill in the art.

The dot and cross products can also be utilized to generate an additional error signal for the initial DPLL function. This automatic frequency control (“AFC”) error signal reflects the sine of the phase difference between the present and prior symbol after correcting for the estimated phase increment between symbols due to the PSK modulation. Mathematical analysis yields a close approximation which can be applied using dot and cross products. The equations are:

AFC_{—}Error_{BPSK}=Cross·Sign[Dot] and,

AFC_{—}Error_{QPSK}=(Cross·Sign[Dot])−(Dot·Sign[Cross]),

respectively, for BPSK and QPSK modulation schemes. The error signals from each of the parallel processing channels are combined and averaged before being fed through the loop filter to the NCO. This function essentially removes minor frequency errors and hence ensures optimal receiver performance.

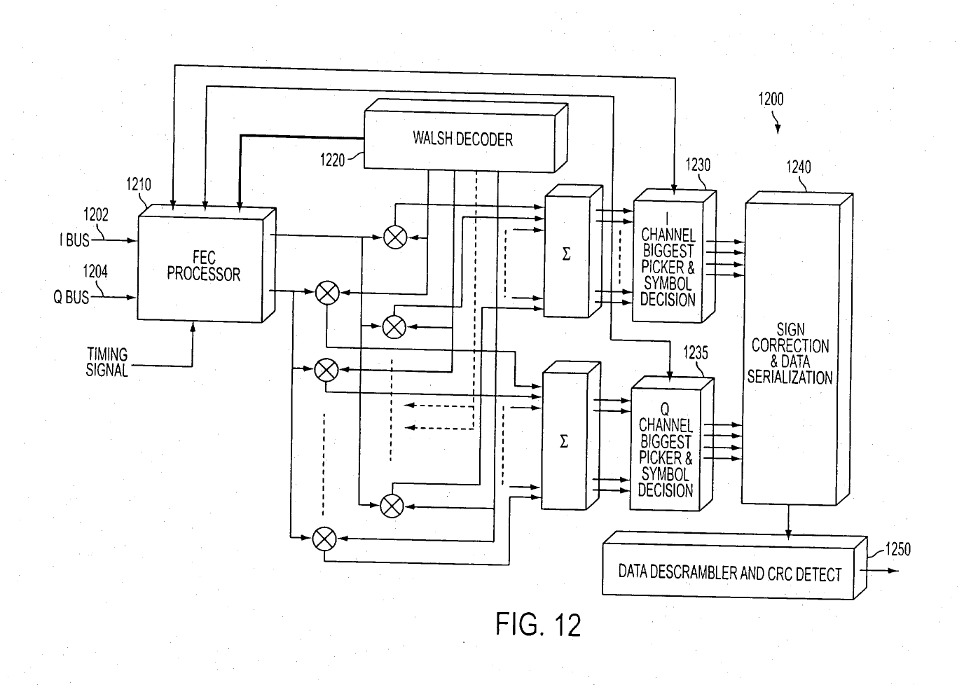

The recovered I and Q data is latched into parallel to serial converters. In another embodiment of the invention, additional signal processing may be required to accommodate interfaces with existing Walsh decoders. The data samples are output in parallel I 1202 and Q 1204 busses to a Walsh code FEC 1210 of a dual channel parallel spread spectrum system 1200 as illustrated in FIG. 12.

The Walsh correlation, demodulation, and FEC processes depend on the parallel despreading sections to correctly remove carrier frequency and phase offsets. The symbol timing processor from the parallel despreading section also provides the phase reference needed to coherently correlate and decode the Walsh code sequences.

FEC processor 1210 examines the I 1202 and Q 1204 data bus and compares the received bytes with one of sixteen (16) possible byte patterns. Intelligent processing is used to correct bit errors within the received I and Q symbols. FEC 1210 operates in conjunction with Walsh decoder 1220 to ensure optimal performance. The orthogonality property of Walsh codes enhances their FEC attributes and hence minimizes BER across a link.

The output from the FEC process is applied to a bank of sixteen (16) correlators (not all shown), eight for each I and Q channel, which multiply the input by the corresponding Walsh code, accumulate, integrate, and dump over the byte period. A “Biggest picker” 1230 for the I channel and a “biggest picker” 1235 for the Q channel analyze the correlation peaks from the respective eight correlators and output the corresponding data for the determined Walsh code to a sign correction and data serialization 1240. The Walsh decode information is routed back to FEC processor 1210 to confirm the Walsh decoder and FEC processes. Irregularities between processes will result in secondary reprocessing of the input sample. Failure of this process will result in generation of an error signal, which can be utilized with the link protocol to initialize a re-transmit algorithm. Once the Walsh codes are successfully decoded, the I and Q data is determined and combined into a signal data stream.

The data stream is descrambled using polynomial division and cycle redundancy checking (“CRC”) is performed on the data packet by a data descrambler and CRC detect 1250. The data is then serially output to a MAC to complete the receiver operation.

The most critical processing area relates to the parallel processing requirements in the receiver. A typical processing cycle from PN acquisition through to data recovery should be implemented in 0.4×Q, where Q equals the acquisition time. For an E1 data stream utilizing the forty-eight (48) bit parallel spreading example illustrated, complete receiver processing is required within 1.5 μs.

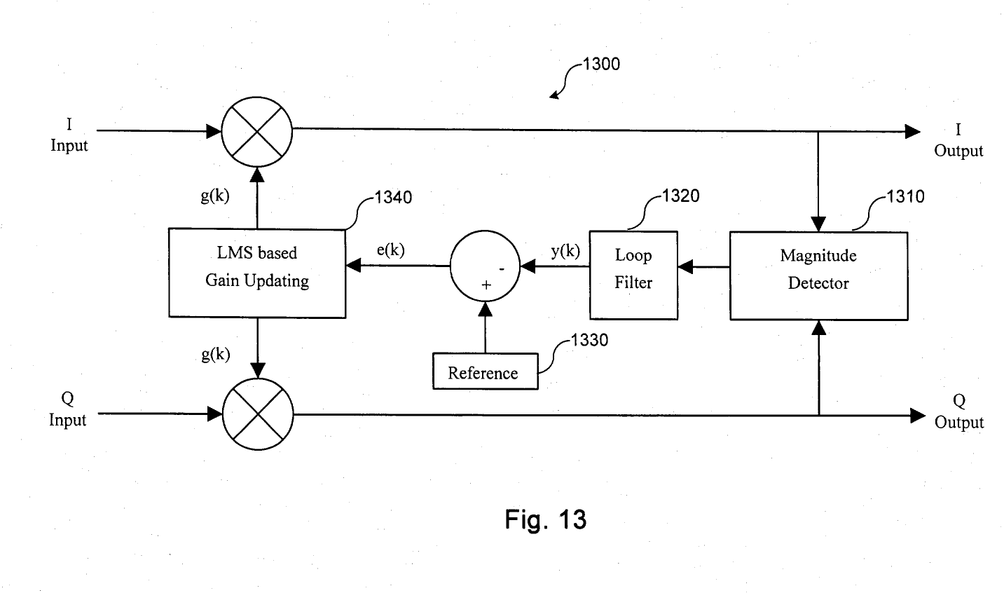

The RF signal power at the receiver 900 can vary greatly depending on the transmitted signal power received and the location of the receiver. In a preferred embodiment of the invention, the signal processed at the receiver is scaled to a predetermined value using an Automatic Gain Control (AGC) loop. Referring to FIG. 13 a block diagram of an AGC loop 1300 is shown according to an embodiment of the invention. In typical applications, the input RF signal to the receiver 900 typically varies in the range of 400 mV peak to peak (P-P) to 800 mV P-P. AGC loop 1300 can be implemented in the receiver 900 to correct this variation and to maintain a constant signal. Particularly, AGC loop 1300 comprises a magnitude detector 1310, a loop filter 1320, a reference signal generator 1330, and a least mean square gain updating circuit 1340. The magnitude detector 1310 calculates the magnitude of the input amplitudes I and Q, y(k), for the I and Q channels respectively, which is equal to the square root of I²+Q². In a digital implementation, an approximate version of this is used and is equal to Max (|I|, |Q|)+½ Min(|I|, |Q|). Loop filter 1332 implements a second order low pass filter to smoothen out the variations in the output of the magnitude detector 1310. An error signal is calculated by subtracting the reference signal obtained from the reference signal generator 1330 from the output of the loop filter 1332. The magnitude of the reference signal is set to a predetermined signal level desired at the output of the AGC loop 1300.

A Least Mean Square (LMS) algorithm based gain vector circuit 1340 is used to update a gain vector by which the input signal is to be scaled. The gain vector is based on an LMS algorithm, which implements the equation

g(k+1)=g(k)·[1+μ·e(k)]

where e(k) is the difference between the reference signal and magnitude y(k), and u is the speed of tracking coefficient, which is typically set at a value of 0.001. If the output from loop filter 1320, y(k), is increases, then e(k) decreases, which in turn results in g(k) increasing the signal amplitudes of I and Q. If y(k) decreases, then y(k) increases, which in turn results in g(k) decreasing the signal amplitudes of I and Q. Such an implementation gives up to 16 dB gain.

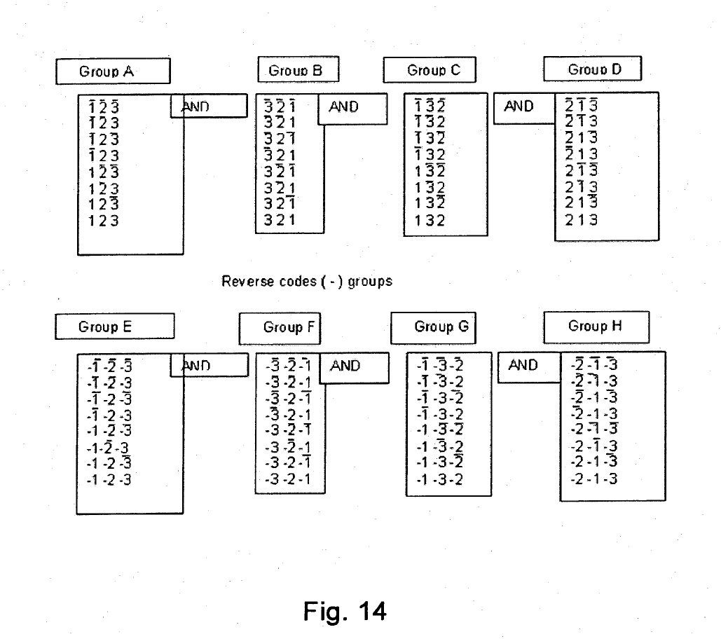

In an embodiment of the invention, the secondary spreading code is a 48-bit PN sequence made of three 16-bit Walsh Codes and serves as the basis for creating code sequences for CDMA applications. In an embodiment of the invention, 1F35, ACF8, and 1F28 (hexadecimal) are employed as the three 16-bit Walsh Codes. One of ordinary skill in the art recognizes that these codes are exemplary only and other 16-bit Walsh Codes may be used as the three 16-bit Walsh Codes. FIG. 14 illustrates possible code sequences that can be derived from the three 16-bit Walsh Codes 1F35, ACF8, and 1F28, referred to as “1”, “2”, and “3”, respectively, organized into particular groups A-H, which are based on all possible permutations transposed from the order “123”. A bar above the code identifier denotes an inverted code. For example, a “3” with a bar over it denotes 1F28 inverted, or EOCA. A negative sign in front of a code identifier denotes a reverse code. For example, a “−3” denotes 1F28 reversed, or ACF8. From these derived sequences, the 10 pairs of codes that are listed in Table 3 (where each code in the code pair is given by group letter and row referenced in FIG. 14) have been found to have a separation of more than 30 dB between the codes that can be used in transceivers 310 and 320 at the same time to achieve suitable orthogonality features from the codes.

The present invention is a novel parallel spread spectrum system and method that combines the orthogonal properties of Walsh codes with the close correlation characteristics of PN-sequences to produce a robust communications technique that can be implemented in point to point or point to multi-point communications links. Independent parallel spreading sequences can be allocated within a network to implement CDMA. In an embodiment of the invention, parallel spreading is dynamic in that the Walsh encoder is programmable and the parallel spreading code length can be varied. A user can determine maximal processing gain for a fixed data rate within an allocated bandwidth.

TABLE 3
Code Pairs With Exceptional Orthogonality Features.

| Actual | | Reverse Code | |
|---|---|---|---|
| Code Pair | Margin in dB | Pair | Margin in dB |
| B5-H0 | 31.345 | Ho-B5 | 31.200 |
| D6-H6 | 31.163 | H6-D6 | 30.980 |
| C0-G2 | 31.255 | G2-C0 | 30.917 |
| B3-G5 | 31.163 | G5-B3 | 30.878 |
| H7-B2 | 31.258 | B2-H7 | 30.722 |
| H0-D4 | 31.373 | D4-H0 | 30.830 |
| F3-C0 | 31.280 | C0-F3 | 30.690 |
| G5-C0 | 31.332 | C0-G5 | 30.697 |
| C5-F7 | 31.120 | F7-C5 | 30.512 |
| F7-D2 | 31.120 | D2-F7 | 30.477 |

The example illustrated in the foregoing description and figures utilizes an eight (8) bit Walsh encoder and a forty-eight (48) bit PN-sequence to achieve a system processing gain of 18.4 dB (9+1.6+7.8), which potentially increases the effective range of a PSS link over a conventional link by an eight fold figure. Alternative embodiments of the invention can have different size Walsh encoders and PN-sequences. It is preferable to use smaller length codes in order to maximize acquisition speed and minimize design complexity.

In another embodiment of the invention, further layered spreading sequences can be implemented to enhance the processing gain and CDMA characteristics. For example, in addition to a secondary spreading sequence, a third sequence may be used in parallel with the primary coding and secondary sequence.

In another embodiment of the invention, coherent demodulation is used to negate the need for differential encoding. In alternative embodiments, a QAM based or coded orthogonal frequency division multiplex technology is used as the modulation scheme.

Although the invention has been particularly shown and described with reference to several preferred embodiments thereof, it will be understood by those skilled in the art that various changes in form and details may be made therein without departing from the spirit and scope of the invention as defined in the appended claims.

What is claimed is:

1. A method of coding data for spread spectrum data communications comprising the steps of:
encoding data with n-bit orthogonal codes;
multiplying a m-bit spreading sequence across an equally divided portion of each of the n-bit orthogonal codes, wherein m is an integer multiple of n.

2. The method of claim 1, wherein said orthogonal codes are Walsh codes.

3. The method of claim 2, wherein n is an integer multiple of eight.

4. The method of claim 1, wherein said spreading sequence is an even ordered code.

5. The method of claim 4, wherein said even ordered code is selected from the group consisting of: M sequence, Barker code, Gold code, Kasami code, pseudo-noise sequence, and a combination thereof.

6. A method of spreading data in a spread spectrum communication system, the method comprising the steps of:
encoding a data stream according to a primary encoding scheme employing primary codes; and
spreading equally divided portions of the primary codes with a secondary sequence, wherein a bit length of said secondary sequence is an integer multiple of a bit length of said primary codes.

7. The method of claim 6, further comprising the step of scrambling said data stream prior to said steps of encoding and spreading.

8. The method of claim 6, wherein said primary codes are Walsh codes.

9. The method of claim 8, further comprising the step of segmenting said data stream into multiple bit data packets representing one of a number of true or inverted Walsh codes.

10. The method of claim 8, further comprising the steps of:
providing synchronization pulses to synchronize said Walsh codes and said secondary sequence, and
holding said data stream in a data storage buffer prior to spreading said data stream with said secondary sequence.

11. The method of claim 6, wherein said secondary sequence is selected from the group consisting of: M sequence, Barker code, Gold code, Kasami code, pseudo-noise sequence, and a combination thereof.

12. The method of claim 6, further comprising the steps of:
modulating said spread data stream; and
transmitting said modulated data stream.

13. The method of claim 12, further comprising the steps of:
receiving said modulated data stream;
converting said received signal into a digitized data stream;
computing a cross correlation between said digitized data stream and a programmed sequence;
utilizing said cross correlation to extract multi-byte samples and byte timing information;
extracting symbol timing information from said extracted multi-byte samples; and
de-modulating said extracted multi-byte samples.

14. A parallel spread spectrum communication device comprising:
an encoder for encoding a data stream according to a primary encoding scheme employing primary codes, and
a spreader for spreading equally divided portions of said primary codes with a secondary sequence.

15. The device of claim 14, wherein said primary codes are n-bit Walsh codes.

16. The device of claim 15, wherein said secondary sequence is a pseudo-noise sequence.

17. The device of claim 16, wherein a bit length of said secondary sequence is an integer multiple of n.

18. The device of claim 14, further comprising:
a modulator; and
a transmitter.

19. A method of deriving code pairs for use in a CDMA communication system, the method comprising:
selecting a number of n-bit orthogonal codes;
ordering said number of n-bit orthogonal codes into a first order;
generating permutations of said first order;
for each permutation of said first order,
generating a first group of unique codes, wherein said step of generating comprises inverting at least one of said number of n-bit orthogonal codes; and
reversing said first group of unique codes to create a reversed group of unique codes;
measuring a separation value between each possible code pair of said groups, wherein each possible code pair consists of one code selected from one of said first groups of unique codes and one code selected from said reversed groups of unique codes, and
determining a set of code pairs, wherein all of the code pairs in said set of code pairs have a measured separation value greater than a predetermined value

20. The method of claim 19, wherein said predetermined value is 30 dB.

21. The method of claim 19, wherein said number is three.

22. The method of claim 19, wherein n is an integer multiple of eight.

23. The method of claim 19, wherein said orthogonal codes are Walsh codes.

24. The method of claim 19, further comprising the step of employing one or more of said code pairs in said set of code pairs in a CDMA communications system.
